(19) United States
(12) Patent Application Publication
(10) Pub. No.: US 2019/0210076 A1
(43) Pub. Date: Jul. 11, 2019

(54) Scraper sponge

(71) Applicant: Alahandro Olatunde Omotola, Leesburg, VA (US)

(72) Inventor: Alahandro Olatunde Omotola, Leesburg, VA (US)

(21) Appl. No.: 16/350,713

(22) Filed: Dec. 27, 2018

Related U.S. Application Data
(60) Provisional application No. 62/763,828, filed on Jul. 5, 2018.
(60) Provisional application No. 62/763,534, filed on Jun. 21, 2018.
(60) Provisional application No. 62/762,775, filed on May 21, 2018.
(60) Provisional application No. 62/762,727, filed on May 18, 2018.

(51) Int. Cl. B08B 7/04; A47L 17/06; A47L 17/08; B08B 1/00

(52) U.S. Cl. CPC B08B 7/04; B08B 1/005; A47L 17/08; A47L 17/06

(57) ABSTRACT

A scraper sponge for cleaning and scraping away unwanted substances from an object or surface comprising a sponge body defining a first surface, a first layer, second layer, third layer, second surface opposite the first surface, a continuous side surface around the perimeter; and a scraper and scraper holder secured in an aperture defining the scraper holder approximately between the first surface and second surface of the sponge body. The scraper, after being inserted into the scraper holder has a tip portion extending outwardly from the scraper holder within the aperture within the sponge body and defining at least 5 edges and a depressible surface concave female groove to which forces are applied to manipulate the rigid scraper. The sponge body is usable with or without the scraper and has two surfaces available for cleaning and scouring; the first surface and second surface. The second layer, third layer, third surface, and continuous side surface are made of the same sponge-like cellulose material. As an alternative, the second layer, third layer, third surface, and a portion of the continuous side surface are not made of the same material and the sponge body has at least three surfaces adapted for cleaning and scouring; the first surface, second surface, and a portion of the continuous side surface. The sponge body is also usable with or without the scraper.

### BACKGROUND OF THE INVENTION

The present invention relates to sponges and, more particularly, to scraper sponges made of natural and/or manmade materials adapted for cleaning and scraping a desired area.

Sponges have been used for many years as a tool for cleaning cookware, utensils, kitchen and bathroom surfaces, automobile surfaces, windows, floors, furniture and a myriad of other objects and surfaces. Sponges are used in these applications in part because they are absorbent, reusable, lightweight, and easy to grasp and manipulate. However, a primary disadvantage of sponges is that by themselves, sponges are too soft and pliable to scrape away unwanted substances such as dirt, hardened oils or grease, mildew, and waxes or foods that stick and adhere to surfaces and reside in corners, grooves and crevices. To remedy this problem, abrasive layers have been added to sponges to enable users to scrape away substances. However, abrasive layers do not effectively allow users to remove substances residing in tight corners, grooves and crevices because neither the sponge nor the abrasive layer provide a rigid enough edge, particularly when saturated with liquid, to enable users to impart the requisite forces necessary for scraping and removing unwanted substances from these tight locations and, in some cases, from flat surfaces as well.

For the foregoing reasons, there is a need for a scraper sponge that enables users to effectively scrape away and remove unwanted substances adhering to flat surfaces and/or found in difficult to reach locations, is easy to grasp and manipulate, is lightweight, and is economical to manufacture for consumer use.

### SUMMARY OF THE INVENTION

Sponges have been used for many years as a tool for cleaning cookware, utensils, kitchen and bathroom surfaces, automobile surfaces, windows, floors, furniture and a myriad of other objects and surfaces. Synthetic sponges, first developed by DuPont in 1940, have since largely replaced authentic sea sponges for household and industrial use.

Sponges are used because they are absorbent, reusable, and lightweight. However, a primary disadvantage of sponges is that by themselves, sponges are too soft and pliable to scrape away unwanted substances such as dirt, hardened oils or grease, mildew, and waxes or foods that stick and adhere to surfaces and reside in corners, grooves and crevices. Abrasive layers do not effectively allow users to remove substances residing in tight corners, grooves and crevices because neither the sponge nor the abrasive layer provide a rigid enough edge, to enable users to impart the requisite forces necessary for scraping and removing unwanted substances from the tight locations and from flat surfaces.

Several types of sponge/scraper implements have been proposed. For example, in U.S. Patent Application No. 2008/0216260 to Silverman et al., an integrated scraper and sponge device is disclosed. While this invention is an improvement upon the use of a sponge alone for removal of difficult and persistent deposits or films, it has several disadvantages. The attachment of the scraper portion to the sponge portion precludes use of the total sponge surface area, making the use of this device inconvenient and allowing the use of only one surface of the sponge. In a second embodiment of the above invention, the scraper of the sponge is not securely inserted into the aperture in the sponge and this docs not allow for easy grasp and use of the scraper without the sponge; the scraper is not wide. Also, use of the sponge in this manner can cause a hand injury as there is no support for the scraper in the soft sponge. Albeit, within the wet frictionless aperture of the sponge. Moreover, the pliable nature of the sponge make grasping the scraper portion all the more difficult for simple and effective removal of unwanted materials. In addition, the scraper is small which is not economical and requires excess scraping to cover a greater surface area. The inventor also does not describe how the blade is movably attached for the disclosed scraper design. Finally, the integral nature of the device only allows for limited reuse, the scraper being not removable as a separate unit by the consumer, necessarily to be discarded when the sponge is discarded.

U.S. Pat. No. 7,984,527 to Georgieff discloses a scraper attachment for sponges that employs a large handle, attachable to the top surface of a sponge, for facile control of the sponge and ergonomic application of hand pressure for effective scraper action. While this device in an improvement over a sponge alone, its design is bulky, and makes access to tight areas difficult if not impossible. The scraper portion of the device does not include a serrated edge, and moreover the application of the device precludes complete use of the sponge surface area. As with the previous disclosure, this device only works with one type of sponge. Other examples include U.S. Pat. No. 4,724,568 to Englehardt, describing a scraper formed integrally with a sponge pad.

U.S. Pat. No. 9,138,121 to Baarsch et al. discloses a scraper attachment for select sponges. It requires the process of impaling a pointed rod through the sponge to work; this can be unsafe. It is bulky, not economical, and only one side of the sponge can be used with this device.

The consumer is faced with few choices of such devices that are currently available on the market, and further rebuffed by the limitations of such devices that have been disclosed above. Proctor and Gamble Company currently have at least two integrated sponge/scraper combination products on the market, distributed by Butler Home Products LLC. These products are largely not reusable, difficult to hold, and one of these products completely covers the top surface of the sponge, reducing the usable area of the sponge.

A device offering total flexibility to be used for all cleaning applications is currently not available on the market. Furthermore, the consumer cannot find a scraper sponge that is lightweight, easily grasped and manipulated, comfortable in the hand, allows for reuse of the scraper independent of the life of the sponge, allows use of three sides of the sponge and that is economical to manufacture for consumer use. Hence, there is a need for a scraper sponge of this magnitude.

### BRIEF DESCRIPTION OF THE DRAWINGS

FIG. 1 is an isometric top frontal perspective view of the scraper sponge according to an embodiment of the invention.

FIG. 2A is an isometric top perspective view of the scraper of FIG. 1.

FIG. 2B is an isometric bottom perspective view of the scraper of FIG. 1.

FIG. 3 is an isometric side perspective view of the scraper of FIG. 2A & FIG. 2B.

FIG. 4 is a front perspective view of the scraper holder according to an embodiment of the invention.

FIG. 5 is a rear top perspective view of the scraper holder of FIG. 4.

FIG. 6 is a rear perspective view of the scraper holder of FIG. 4.

FIG. 7 is an angled transparent right frontal view of the scraper sponge according to an embodiment of the invention.

FIG. 8 is an angled and exploded left frontal view of the scraper sponge according to an embodiment of the invention.

FIG. 9 is a left side view of the scraper sponge according to an embodiment of the invention.

FIG. 10 is a top perspective view of the scraper sponge of FIG. 9 according to an embodiment of the invention.

FIG. 11 is a rear perspective view of the scraper sponge of FIG. 9 according to an embodiment of the invention.

FIG. 12 is a left side view of the scraper sponge according to an embodiment of the invention.

FIG. 13 is a right side view of the scraper sponge of FIG. 12 according to an embodiment of the invention.

FIG. 14 is an angled and exploded right frontal view of the scraper sponge according to a second embodiment of the invention.

FIG. 15 is an angled and assembled right frontal view of FIG. 14 according to a second embodiment of the invention.

FIG. 16 is an angled right side frontal view of the scraper sponge according to a third embodiment of the invention.

FIG. 17 is an angled left side frontal view of FIG. 16 according to a third embodiment of the invention.

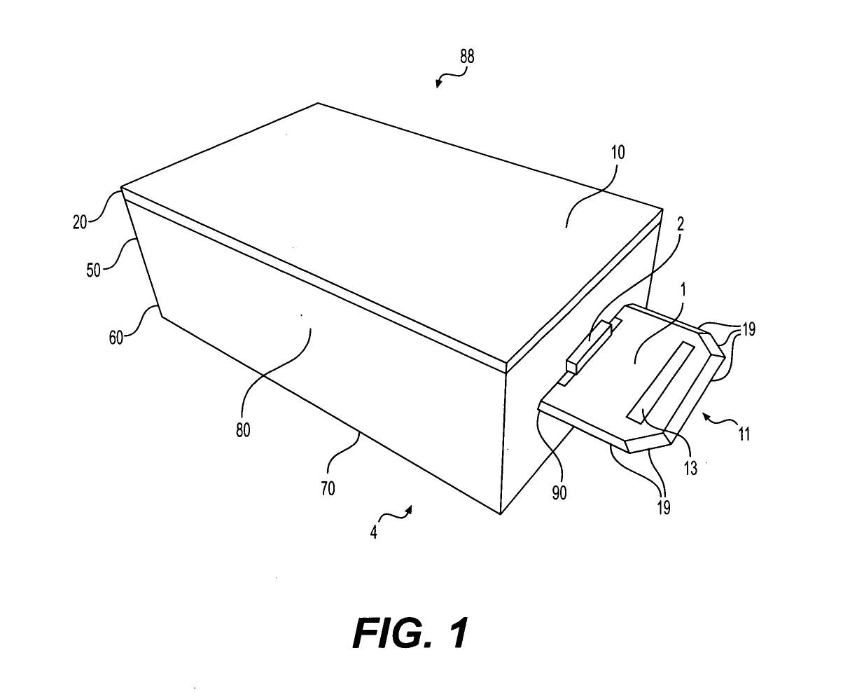

### DETAILED DESCRIPTION OF THE INVENTION

The present invention is directed to a scraper sponge and/or pad adapted for scraping and removing unwanted substances such as dirt, hardened oils or grease, mildew, waxes, stuck on foods, or other substances that adhere to surfaces and reside in corners, grooves and crevices.

Referring to FIGS. (7 thru 13) an embodiment of the scraper sponge is shown and generally indicated by reference numeral 88. The scraper sponge 88 comprises a sponge body 4 defining a first surface 10, second surface 70 opposite first surface, and a continuous side surface 80 around the perimeter. The sponge body 4 can be made from numerous materials such as polyester foam, natural sponges, polyurethane foams, cellulose fiber, absorbent arrays of synthetic fibers or any combination thereof. The invention is not limited in this regard, and any appropriate sponge material that is currently known or later becomes known to those skilled in the art may be used. In one embodiment, the sponge body 4 is rectangular. However, the invention is not limited in this regard as the sponge body 4 could be any shape appropriate for cleaning such as polygon, oval, square, circle, triangle, trapezoid, etc.

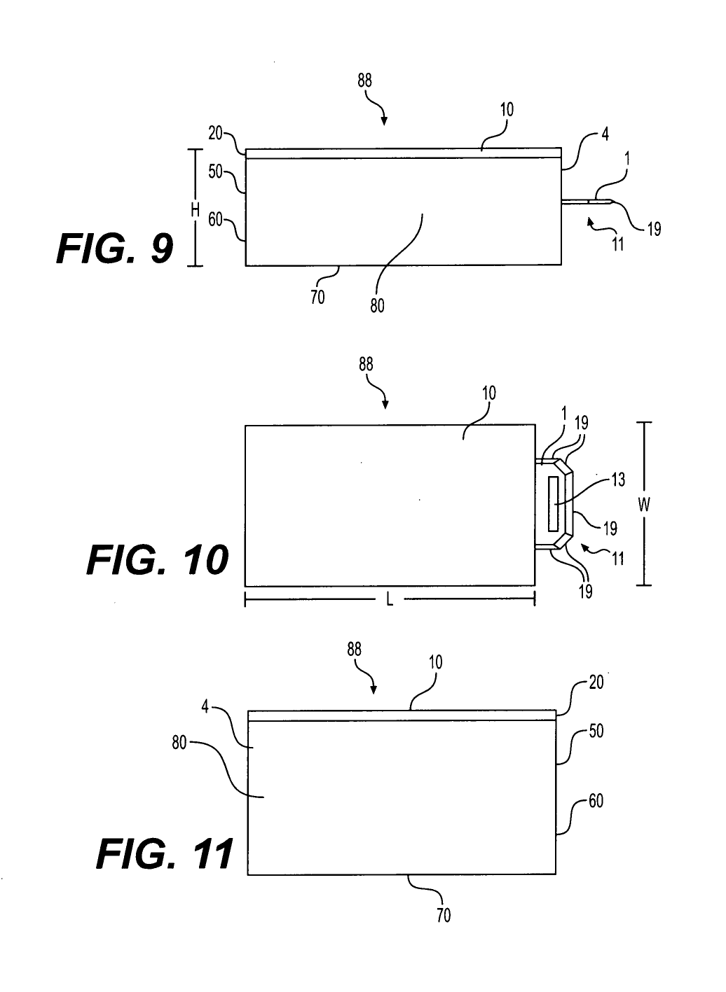

Furthermore, the sponge body 4 is not limited by size in any dimension. In one embodiment, the length L (FIG. 10) of the sponge body 4 ranges from about 3 inches to about 23 inches, while the width W (FIG. 10) ranges from about 2 inches to about 15 inches; for circular sponges (not shown), the diameter ranges from about 3 inches to about 16 inches. In another embodiment, the length L of the sponge body 4 ranges from about 3 inches to about 14 inches, while the width W ranges from about 2 inches to about 7 inches; for circular sponges, the diameter ranges from about 3 inches to about 12 inches. In yet another embodiment, the length L of the sponge body 4 ranges from about 4 inches to about 12 inches, while the width W ranges from about 2 inches to about 4 inches; for circular sponges, the diameter ranges from about 4 inches to about 8 inches. With respect to the thickness H (FIG. 9) of the sponge body 4, in one embodiment, the thickness H ranges from about 1 inch to about 4.5 inches. In another embodiment, the thickness H of the sponge body 4 ranges from about 1 inch to about 7 inches. In yet another embodiment, the thickness H of the sponge body 4 ranges from about 1 inch to about 3 inches.

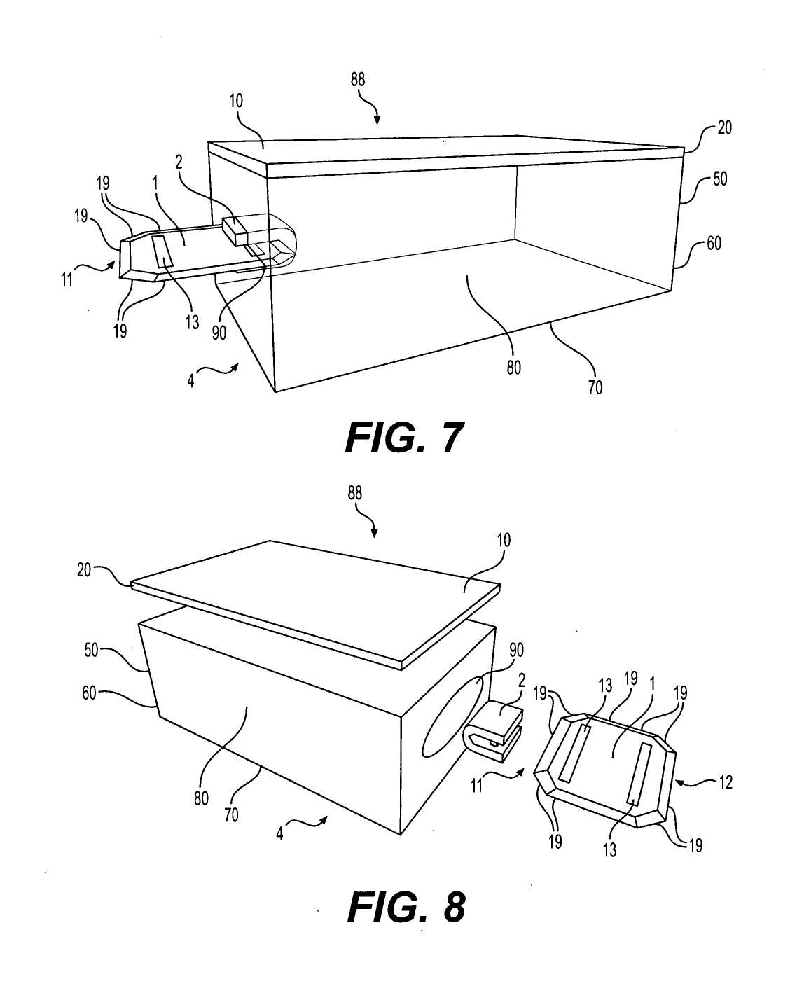

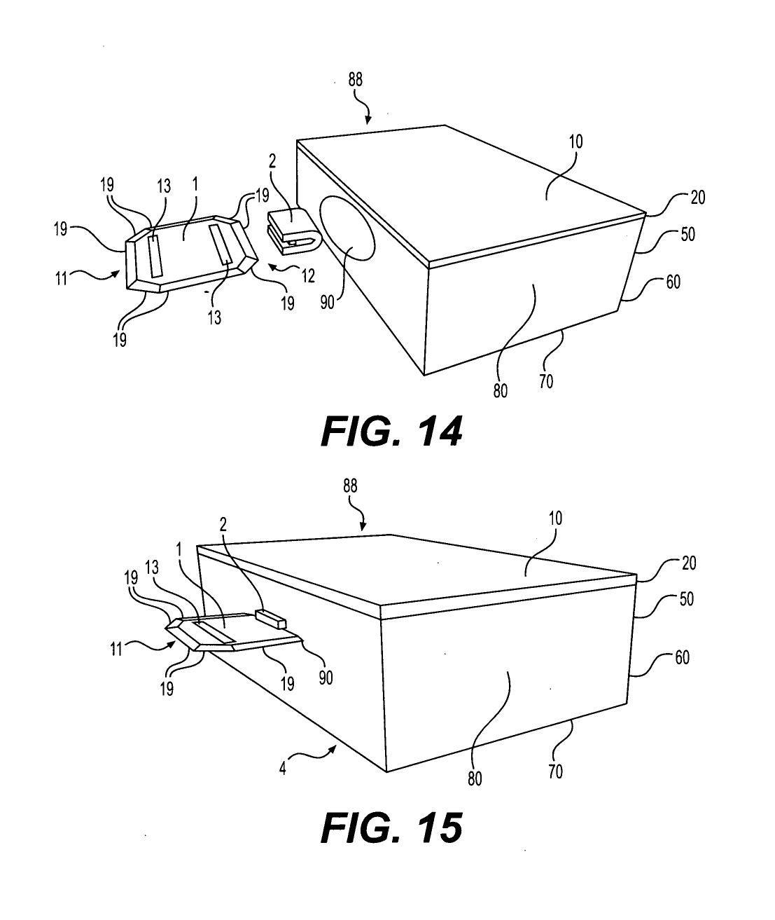

Referring to FIGS. 7,12,13) the scraper sponge 88 defines a sponge body 4 defining an outer continuous side surface 80 including a first surface 10, a second surface 70, and a scraper holder 2 inserted into an aperture 90 within side surface 80 and extending through the side surface 80 for receiving the scraper 1. An exploded view of the scraper sponge 88 is shown in FIG. 8. In one embodiment, a blade holder 2 is fixedly secured within aperture 90 of sponge body 4 approximately halfway between the second layer 50 and the third layer 60 of the scraper sponge 88 on the width-side (FIG. 10) of the continuous side surface 80 by way of heat fusion and/or the application of an adhesive (not shown), or by any other method that is currently known or later becomes known to one skilled in the art. In another embodiment, (FIG. 15) the blade holder 2 can be placed on the length-side (FIG. 10) of scraper sponge 88 between the first surface 10 and second surface 70 of sponge body 88. An exploded view of this is presented in FIG. 14.

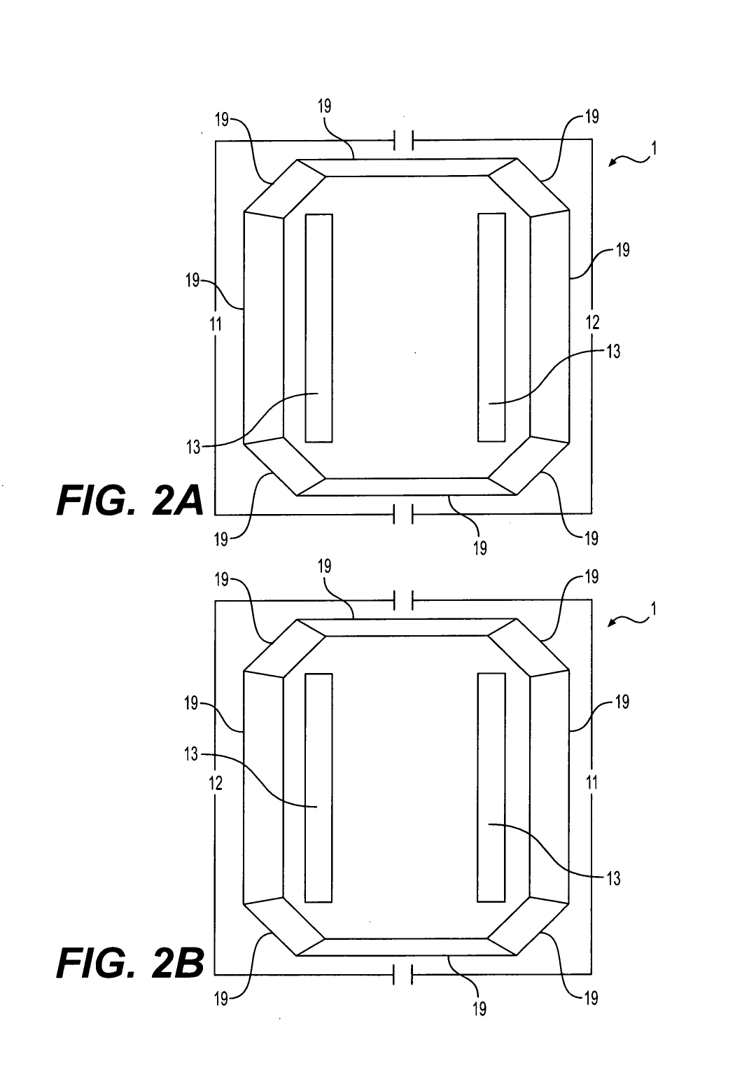

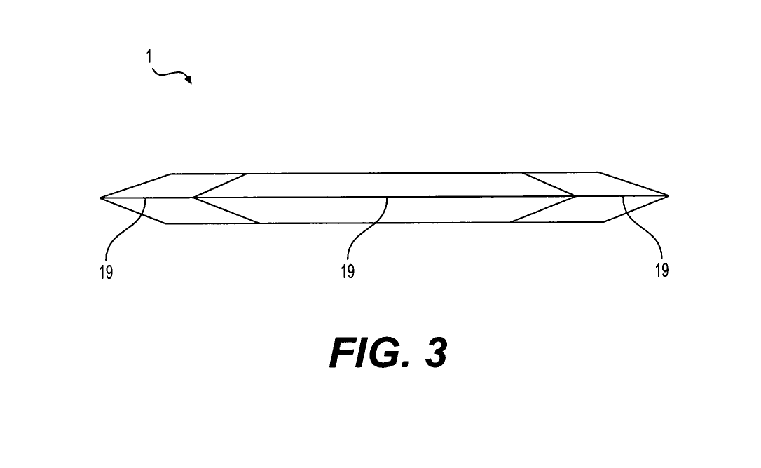

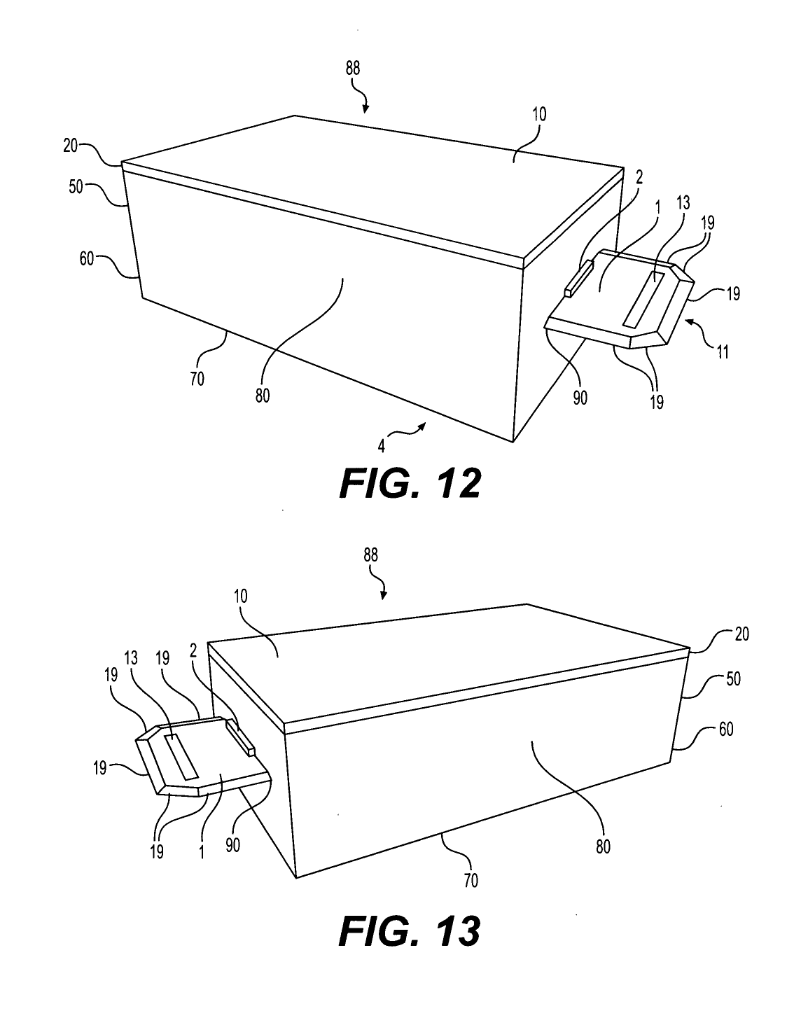

The scraper 1 is movably attached to the blade holder 2 that is attached to the sponge body 4 allowing the user to attach and remove the blade as needed. The scraper 1 has eight defined edges 19 (FIGS. 2a and 2b) divided into a tip portion 11 and 12 (FIGS. 2a and 2b). When scraper 1 is inserted into scraper holder 2 tip portions 11 or 12 extend outwardly from the blade holder 2 within the sponge body 4 and tapers into at least 5 defined edges 19 along the perimeter of tip portion 11 and 12. In one embodiment (FIG. 12), the tip portion 11 extends outwardly from the blade holder within the sponge body 4. In an alternative embodiment (FIG. 13) the tip portion 12 extends outwardly from the blade holder within the sponge body 4. Tip portions 11 and 12 are identical. The scraper 1 edges range from being semi rigid to substantially rigid for scraping unwanted substances and is narrow at its apex for entering tight corners, groves and crevices and for effectively scraping surfaces. Further, the scraper 1 defines 4 depressible surface concave female grooves 13 to which normal and angular forces are applied by the user to manipulate the scraper 1 and apply pressure as required to scrape away and remove substances where desired. The scraper 1 and holder 2 can be made from numerous materials such as natural rubber, synthetic rubber, plastics, polymers, wood, metal or any combination thereof. The invention is not limited in this regard, and any appropriate scraper material that is currently known or later becomes known to those skilled in the art may be used. For improved manipulation and scraping, the depressible surface concave female grooves 13 is contoured in a concave-like manner and, depending on the size, is adapted for receiving at least a portion of: (i) a human finger, (ii) multiple human fingers, (iii) a human hand, or (iv) two human hands, for applying pressure and manipulating the scraper 1 as noted above.

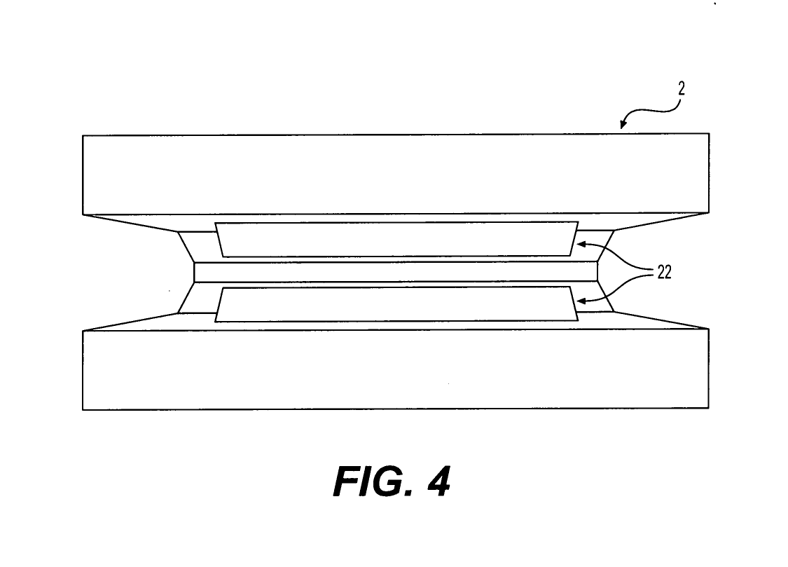

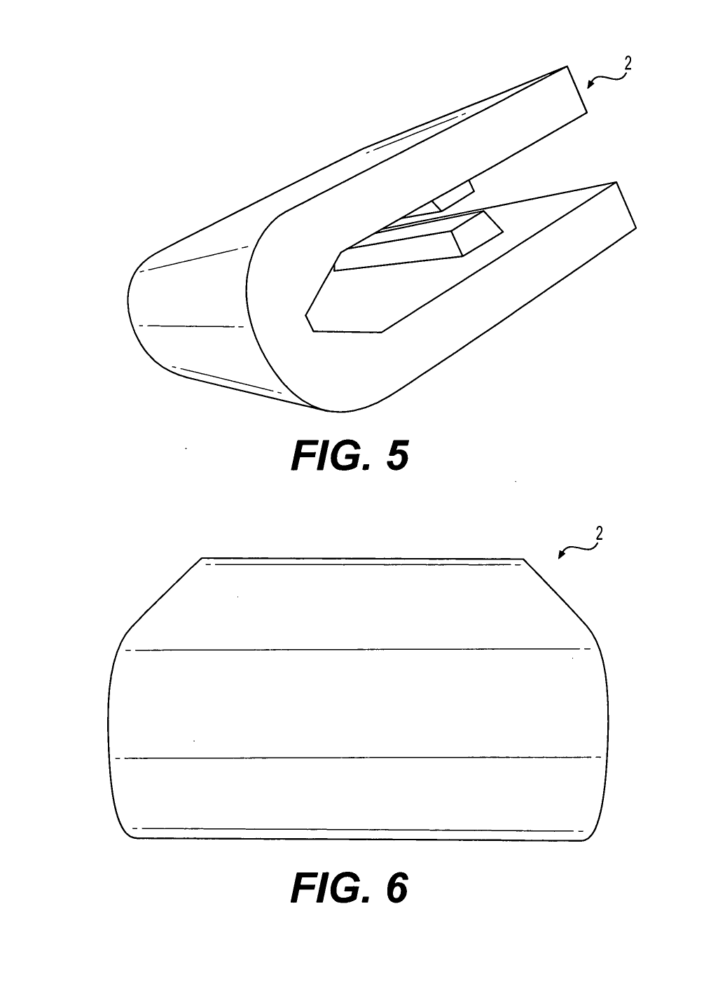

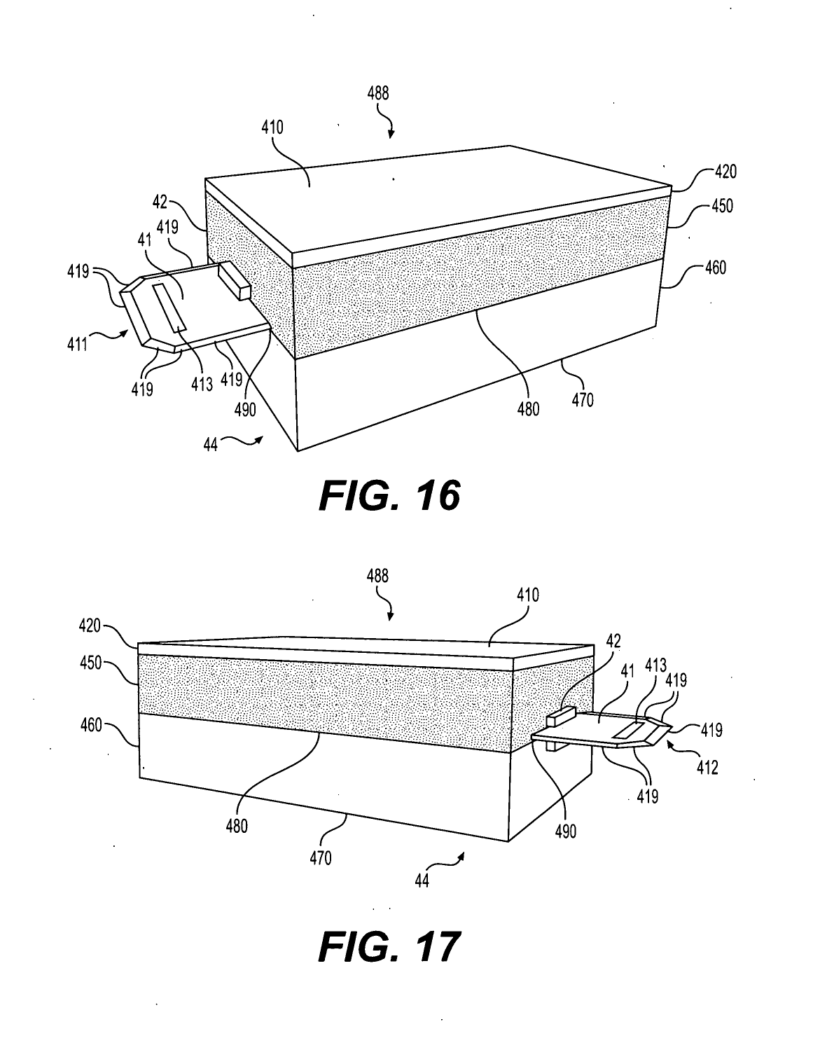

In one embodiment, shown in (FIGS. 12 and 13), the sponge body 4 comprises multiple layers including a first layer 20 defining the first surface 10, a second layer 50 defining a third layer 60 defining a second surface 70. The first layer 20 and second layer 50 are heat fused and/or bonded together using an adhesive (not shown), or by any method that is currently know or later becomes known to those skilled in the art. In one embodiment, the second layer 50, third layer 60, and second surface 70, are made of the same material and are heat fused and/or bonded together using an adhesive (not shown), or by any method that is currently know or later becomes known to those skilled in the art. The first surface 10 and first layer 20 can be made from numerous materials such as nylon, polypropylene, polyester foam, melamine, natural sponges, polyurethane foams, cellulose, and absorbent arrays of synthetic fibers, non-woven materials or any combination thereof. The second layer 50, third layer 60, and second surface 70, can be made from numerous materials such as nylon, polypropylene, polyester foam, melamine, natural sponges, polyurethane foams, cellulose, and absorbent arrays of synthetic fibers, non-woven materials or any combination thereof. In one embodiment, the first surface 10 and first layer 20 are made from nylon. The second layer 50, third layer 60, and second surface 70 are indistinguishable and made from cellulose fiber. In one embodiment, (FIGS. 12 and 13), the scraper 1 is secured within blade holder 2 by male appendages 22 (FIG. 4); which fit securely into depressible surface concave surface female grooves 13 of scraper blade 1 (FIGS. 2a and 2b). Blade holder 2 is fixedly secured within sponge body 4 approximately halfway between the second layer 50 and the third layer 60 of the scraper sponge 88 on the width-side of the continuous side surface 80. The thickness of the second layer 50 and third layer 60 may comprise approximately 85% to about 90% of the total thickness of the scraper sponge 88. Preferably, the first layer 20 comprises between about 10% to about 20%, of the total thickness of the scraper sponge 88. In an alternative embodiment, (FIGS. 16 and 17) the first layer 420 and second layer 450 comprise about 40% of the total thickness of the sponge body 488 and the third layer 460 comprises about 60%. All three layers can be made of different types of surface scrubbing materials.

Referring now to (FIGS. 16 and 17), an alternative embodiment is shown where like numerals represent like elements and are preceded with the number “4”. In this embodiment, the scraper sponge 488 defines a sponge body 44 defining an outer surface including a first surface 410, a first layer 420, a second layer 450, a third layer 460 including a second surface 470, a continuous side surface 480, and an aperture 490 extending through the side surface 480 for receiving the scraper holder 42. The scraper holder 42 is fixedly secured within the aperture 490 by way of heat fusion or by an adhesive (not shown), and like the scraper described above, has tip portions 411 and 412 defining an edge 419 and a depressible surface concave female groove 413 to which forces are applied to manipulate the scraper. For improved manipulation and scraping, the depressible surface concave female grooves 413 is contoured in a concave-like manner and, depending on the size, is adapted for receiving at least a portion of: (i) a human finger, (ii) multiple human fingers, (iii) a human hand, or (iv) two human hands, for applying pressure and manipulating the scraper 41 as noted above. The tip portions 11 and 12 and the depressible surface concave female grooves 413 extend outwardly from the blade holder 42 within the aperture 490 in the sponge body 44. In this embodiment the materials used for the sponge body 44, blade holder 42 and blade 41 are consistent with the materials used in connection with the sponge body 4, blade holder 2, and scraper 1 described above. As noted above, the sponge body 44 can comprise a first layer 420, a second layer 450, and a third layer 460. At least one of the second 450 or third layers 460 defines the aperture 490 where the scraper holder 42 is inserted. The materials used for the first layer 420, second layer 450, and third layer 460 are consistent with the materials used in connection with the sponge body 44 and scraper 41 described above. One advantage of this embodiment is that it allows each layer 420, 450, and 460 to be made of a different textured material to be used for scrubbing and cleaning and/or polishing a surface. For example, layer one 420 can be made of a coarse grain scouring material, the continuous side surface 480 of the second layer 450 can be made of a melamine resin material, and the third layer 460 can be made of cellulose fiber.

In light of the above description of the scraper sponge 88 and 488 an example of its use will now be described. With the scraper sponge 88, 488 and/or the desired object or surface for cleaning (not shown) prepared with water, soap, cleaning liquids, cleaning powders, or the like, the user places the sponge body 4, 44 in contact with said object or surface. The user then presses on the depressible surface concave female grooves imparting downward pressure on the scraper 2, 42 and sponge body 4, 44. The sponge body with pressure applied to the scraper 1, 41 and, in particular, the edge 19, 419, of the scraper, is moved into position for contacting and scraping unwanted substances in a desired location. While maintaining the applied pressure, the user simultaneously moves the sponge body 4, 44 and scraper 1, 41 in, for example, a forward or reciprocating motion to effectively scrape away and remove the unwanted substances. When the user is finished, both the sponge body and scraper can be cleaned for future applications. It should be noted that the sponge body 4, 44 can be used for cleaning and scouring purposes without inserting or engaging the scraper 1, 41. The scraper 1, 41 can be used without the sponge body 4, 44. Further, the scraper sponge 88, 488 can be used in a dry state without the addition of water, soap, cleaning liquids, cleaning powders, or the like.

The claimed invention is:

1. A scraper sponge comprising: a sponge body defining a first surface, a first layer, second layer, third layer, second surface opposite the first surface, a continuous side surface around the perimeter; and a scraper holder secured in an aperture defining the scraper holder approximately between the first layer and second layer of the sponge body; the scraper, after being inserted into the scraper holder has a tip portion extending outwardly from the scraper holder within the aperture within the sponge body and defining at least 5 edges and a depressible surface concave female groove to which forces are applied to manipulate the scraper.

2. The scraper sponge of claim 1, wherein said sponge body is made of material selected from the group consisting of polyester foam, natural sponges, polyurethane foams, cellulose, absorbent arrays of synthetic fibers and any combination thereof.

3. The scraper of claim 1, wherein said scraper is made of material selected from the group consisting of natural rubber, synthetic rubber, polymers, wood, metal and any combination thereof.

4. The scraper of claim 3, wherein said scraper is thin and octagonal in shape.

5. The scraper of claim 3, wherein said scraper is movable secured to the scraper holder.

6. The scraper holder of claim 1, wherein said scraper holder is made of material selected from the group consisting of natural rubber, synthetic rubber, polymers, wood, metal and any combination thereof.

7. The scraper sponge of claim 1, wherein said scraper holder is defined by an aperture, a continuous side surface, layer one, and layer two and is fixedly secured in the aperture approximately between the first layer and second layer of the sponge body by way of an adhesive, by heat fusion or any combination thereof.

8. The scraper of claim 3, wherein said scraper surface has four depressible surface concave female grooves, two on each side of the scraper, that are contoured for receiving at least a portion of one or more human fingers.

9. The scraper of claim 8, wherein said scraper has a total of at least eight edges that are at least one of (i) semi rigid and (ii) substantially rigid.

10. The scraper holder of claim 6, wherein said scraper holder is at least one of (i) semi rigid and (ii) substantially rigid.

11. The scraper holder of claim 6, wherein said scraper holder is custom designed to securely fit and hold the scraper and said scraper holder has male appendages that fit securely into the depressible surface concave female grooves of the scraper locking it in place when the scraper is inserted into the holder.

12. The scraper sponge of claim 1, wherein said sponge body comprises multiple layers including a first layer defining the first surface and second layer, second layer defining a third layer and a third layer defining the second surface.

13. The scraper sponge of claim 12, wherein said first surface is made of a coarse grain scouring material.

14. The scraper sponge of claim 12, wherein said second layer is made of cellulose fiber and the scraper holder is secured in an aperture approximately between the second and third layer.

15. The scraper sponge of claim 12, wherein said third layer is made of cellulose fiber and the scraper holder is secured in an aperture approximately between the second and third layer.

16. The scraper sponge of claim 12, wherein the thickness of said first layer is between approximately 10% and about 15% of the thickness of the scraper sponge.

17. The disposable liquid absorbing cleaning material of claim 14, wherein the total thickness of said second layer is approximately 40% to about 45% of the total thickness of the scraper sponge.

18. The disposable liquid absorbing cleaning material of claim 15, wherein the total thickness of the said third layer is between about 40% to about 45% of the total thickness of the scraper sponge.

19. A scraper sponge comprising: a sponge body defining a first surface, a first layer, second layer, third layer, second surface opposite the first surface, a continuous side surface around the perimeter, and a scraper holder secured in an aperture defining the scraper holder approximately between the first surface and second surface of the sponge body, and the scraper after being inserted into the scraper holder has a tip portion extending outwardly from the scraper holder within the aperture within the sponge body and defining at least 5 edges and a depressible surface concave female groove to which forces are applied to manipulate the scraper.

20. The scraper sponge of claim 19, wherein said sponge body is made of material selected from the group consisting of polyester foam, natural sponges, polyurethane foams, cellulose, absorbent arrays of synthetic fibers and any combination thereof.

21. The scraper of claim 19, wherein said scraper is made of materiel selected from the group consisting of natural rubber, synthetic rubber, polymers, wood, metal and any combination thereof.

22. The scraper of claim 21, wherein said scraper is thin and octagonal in shape.

23. The scraper of claim 21, wherein said scraper is movable secured to the scraper holder.

24. The scraper holder of claim 19, wherein said scraper holder is made of material selected from the group consisting of natural rubber, synthetic rubber, polymers, wood, metal and any combination thereof.

25. The scraper holder of claim 24, wherein said scraper holder is defined by an aperture within a continuous side surface, and one of layer one or layer two, and is approximately between the first and second surface of the sponge body, and is fixedly secured within the aperture by way of an adhesive, by heat fusion or any combination thereof.

26. The scraper of claim 21, wherein said scraper surface has four depressible surface concave female grooves, two on each side of the scraper, that are contoured for receiving at least a portion of one or more human finger tips.

27. The scraper of claim 21, wherein said scraper has at least eight edges that are at least one of (i) semi rigid and (ii) substantially rigid.

28. The scraper holder of claim 24, wherein said scraper holder is at least one of (i) semi rigid and (ii) substantially rigid.

29. The scraper holder of claim 24, wherein said scraper holder is structurally reinforced to resist collapsing due to normal and excessive squeezing of scraper sponge 88.

30. The scraper holder of claim 24, wherein said scraper holder is custom designed to securely fit and hold the scraper; the scraper holder has male appendages that fit securely into the depressible surface concave female grooves of the scraper locking it in place when the scraper is inserted into the holder.

31. The scraper sponge of claim 19, wherein said sponge body comprises multiple layers including a first layer defining the first surface and second layer, a second layer defining a third layer and a third layer defining a second surface.

32. The scraper sponge of claim 31, wherein said first layer is made of a coarse grain scouring material.

33. The scraper sponge of claim 31, wherein said second layer is made of melamine or a similar material and the scraper holder is secured in an aperture defined by a continuous side surface, and one of layer one or layer two and is approximately between the first surface and second surface of the scraper sponge.

34. The scraper sponge of claim 31, wherein said third layer is made of cellulose fiber or similar material and the scraper holder is secured in an aperture within layer one or layer two and defined by a continuous side surface, approximately between the first surface and second surface of the scraper sponge.

35. The scraper sponge of claim 31, wherein the thickness of said first layer is between approximately 10% and about 15% of the thickness of the scraper sponge.

36. The disposable liquid absorbing cleaning material of claim 33, where the total thickness of said second layer is approximately 35% to about 40% of the total thickness of the scraper sponge.

37. The disposable liquid absorbing cleaning material of claim 34, wherein, the total thickness of said third layer is between about 45% to about 50% of the total thickness of the scraper sponge.
